(19) United States
(12) Patent Application Publication
(10) Pub. No.: US 2024/0153239 A1
(43) Pub. Date: May 9, 2024

(54) MULTIMODAL IDENTIFICATION OF OBJECTS OF INTEREST IN IMAGES

(71) Applicant: Meta Platforms, Inc., Menlo Park, CA (US)

(72) Inventors: Jun Chen, Bellevue, WA (US); Wenwen Jiang, Menlo Park, CA (US); Licheng Yu, Jersey City, NJ (US)

(73) Assignee: Meta Platforms, Inc., Menlo Park, CA (US)

(21) Appl. No.: 18/054,026

(22) Filed: Nov. 9, 2022

(51) Int. Cl. G06V 10/74; G06V 10/22; G06V 10/764; G06V 10/774; G06V 10/82; G06V 20/62

(52) U.S. Cl. CPC G06V 10/761; G06V 10/225; G06V 10/764; G06V 10/774; G06V 10/82; G06V 20/62

(57) ABSTRACT

Technology for identifying an object of interest includes obtaining object embeddings for a plurality of objects in an image, obtaining text embeddings for text associated with the image, determining, for each of the plurality of objects, a similarity score via a similarity model based on the text embeddings and the object embeddings, while bypassing use of bounding box coordinates, and selecting the object having the highest similarity score as the object of interest. In another example, technology for identifying an object of interest includes obtaining object embeddings for a plurality of objects in an image, obtaining text embeddings and text identifiers for text associated with the image, generating, via a single transformer encoder, a set of CLS embeddings based on the text embeddings and the object embeddings, and determining, via a neural network, the object of interest based on the CLS embeddings.

### TECHNICAL FIELD

Examples generally relate to computing systems. More particularly, examples relate to identifying objects of interest in images based on multimodal input data.

### BACKGROUND

Finding the main product mage is very critical in applications such as those providing product retrieval. Identifying the wrong item will lead to incorrect search results and this will negatively affect the user experience. Current product detection schemes generally rely just on the image data and return many bounding boxes, among which the one with the largest area and/or closest to the image center is typically identified as the main product, but which in many instances incorrectly identifies the object that is actually of interest.

### SUMMARY OF PARTICULAR EXAMPLES

In accordance with one or more examples, a method of identifying an object of interest includes obtaining object embeddings for each of a plurality of objects in an image, each object associated with a bounding box and a bounding box identifier, obtaining text embeddings for text associated with the image, determining, for each of the plurality of objects, a similarity score via a similarity model based on the text embeddings and the object embeddings for the respective object, wherein determining a similarity score comprises bypassing use of bounding box coordinates, and selecting the object having the highest similarity score as the object of interest.

In accordance with one or more examples, a computing system to identify an object of interest includes a processor, and a memory coupled to the processor, the memory comprising instructions which, when executed by the processor, cause the computing system to perform operations comprising obtaining object embeddings for each of a plurality of objects in an image, each object associated with a bounding box and a bounding box identifier, obtaining text embeddings for text associated with the image, determining, for each of the plurality of objects, a similarity score via a similarity model based on the text embeddings and the object embeddings for the respective object, wherein determining a similarity score comprises bypassing use of bounding box coordinates, and selecting the object having the highest similarity score as the object of interest.

In accordance with one or more examples, a method of identifying an object of interest includes obtaining object embeddings for each of a plurality of objects in an image, each object associated with a bounding box and a bounding box identifier, obtaining text embeddings and text identifiers for text associated with the image, generating, via a single transformer encoder, a set of CLS embeddings based on the text embeddings and the object embeddings, and determining, via a neural network, the object of interest based on the CLS embeddings.

### BRIEF DESCRIPTION OF THE DRAWINGS

The various advantages of the examples will become apparent to one skilled in the art by reading the following specification and appended claims, and by referencing the following drawings, in which:

FIG. 1 provides a block diagram illustrating an overview of an example computing system for identifying an object of interest according to one or more examples;

FIGS. 2A-2C provide diagrams illustrating an example computing system for identifying an object of interest according to one or more examples;

FIG. 3A provides a flow diagram illustrating an example method of identifying an object of interest according to one or more examples;

FIG. 3B provides a flow diagram illustrating an example method of determining a similarity score according to one or more examples;

FIGS. 4A-4D provide diagrams illustrating an example computing system for identifying an object of interest according to one or more examples;

FIG. 5 provides a flow diagram illustrating an example method of identifying an object of interest according to one or more examples; and

FIG. 6 is a block diagram illustrating an example of an architecture for a computing system for use in identifying an object of interest according to one or more examples.

### DESCRIPTION OF EXAMPLES

An improved computing system as described herein provides an improved computing system to identify an object of interest in an image based on image data and on text associated with the image. The technology as described herein helps improve the overall performance of object detection systems by providing a more robust and reliable identification of objects that are of interest to users—such as, e.g., in product search applications. The technology as described herein also provides a simpler, more streamlined architecture than other solutions, resulting in reduced inference latency and number of computing units (e.g., machines) required.

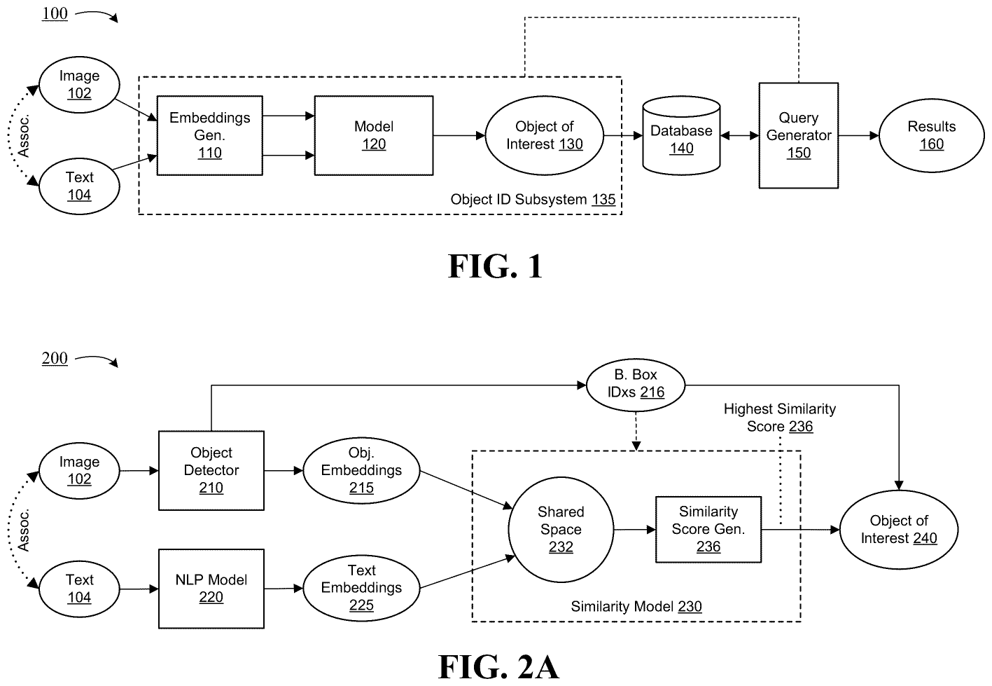

FIG. 1 provides a block diagram illustrating an overview of an example computing system 100 for identifying an object of interest according to one or more examples, with reference to components and features described herein including but not limited to the figures and associated description. As shown in FIG. 1, the system 100 receives as input an image 102 and associated text 104, where the text 104 is associated with the image 102. The image 102 can include any example or type of image that is of interest to a user such as, e.g., images captured by users, published images, etc. The image 102 typically includes one or more objects, including an object of interest. The text 104 can be text in or accompanying the image such as, e.g., text entered in a user post with an image, a caption accompanying a published image, etc. The text 104 can typically include information that identifies or describes an object in the associated image (e.g., the object of interest).

The system 100 includes an embeddings generation stage 110 and a model 120. The embeddings generation stage 110 operates to generate embeddings for the image 102 and the text 104. The embeddings generation stage 110 can include separate embeddings generators (not shown in FIG. 1) such as, e.g., an object embeddings generator to generate object embeddings for objects in the image 102 and a text embeddings generator to generate text embeddings for the text 104. Output from the embeddings generation stage 110—e.g., object embeddings for objects in the image 102 and text embeddings for the text 104—are provided to a model 120. In examples the object embeddings generator (e.g., an object detector) operates on the image 102 and generates, for each detected object, object embeddings and a bounding box identifier, where each detected object has an associated bounding box.

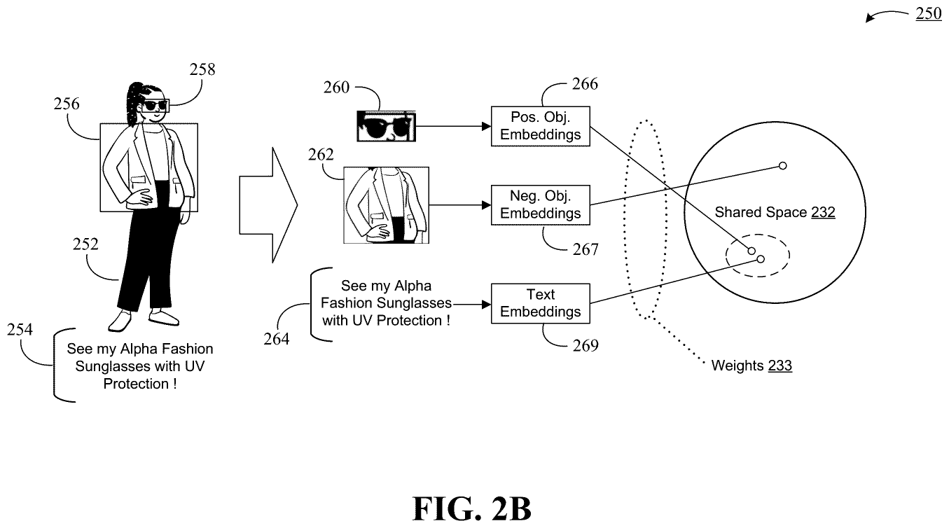

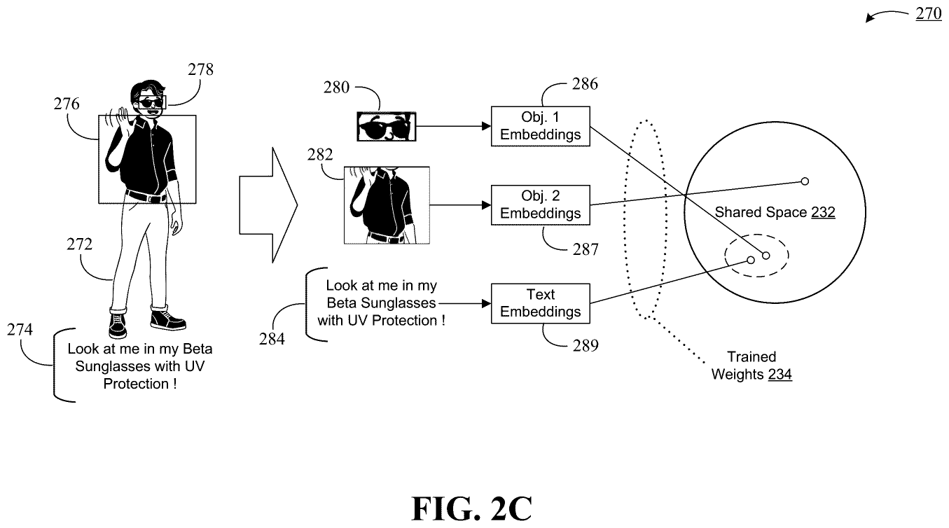

The model 120 is a model trained to predict (e.g., identify) an object of interest in the image 102 based not only on object embeddings (e.g., object embeddings generated from the image 102) but also on text embeddings (e.g., text beddings generated from the text 104). The model 120 operates to predict an object of interest 130 based on the embeddings (e.g., the object embeddings and the text embeddings) provided by the embeddings generation stage 110. The object of interest 130 can be a specific object in the image 102 and/or a bounding box associated with the specific object (such as, for example, a box surrounding the object defined by an object detector) in the image 102. In some examples, therefore, the model 120 identifies a specific object (e.g., an object identifier) in the image 102. In some examples, thus, the model 120 identifies a bounding box (e.g., an identifier or an index number for the bounding box) corresponding to an object in the image 102. In some examples, the embeddings generation stage 110, the model 120 and the object of interest 130 form an object identification (ID) subsystem 135. Further details of examples of the embeddings generation stage 110 and the model 120 are provided herein with reference to FIGS. 2A-2C, 3A-3B, 4A-4D and 5.

In examples the system 100 also includes a database 140 and a query generator 150. The database 140 is configured to store the object of interest 130 provided (e.g., predicted) by the model 120. In examples the database 140 stores the object of interest 130 along with the image 102 and/or the text 104. In examples the database 140 will store multiple objects of interest 130 as determined by the model 120 over a course of evaluating many images 102 with associated text 104.

In examples the database 140 is responsive to queries from the query generator 150. The query generator 150 is configured to generate a query that identifies a topic or subject matter of interest, and submit the query to the database 140. The topic or subject matter of interest can be generated based on, e.g., a user search query, a user indication of interest (e.g., clicking on a link or an item associated with a particular topic or subject matter, etc.). Based on the topic or subject matter of interest, the database 140 identifies one or more boxes or objects of interest (e.g., from the stored objects of interest 130), along with associated text stored in the database 140 and provides to the query generator 150. The query generator 150 then provides the information retrieved from the database 140 as results 160.

In some examples the query generator can provide an image and associated text or provide a link or identifier for an image and associated text which are then provided as input (e.g., as the image 102 and the text 104) to the object ID subsystem 135 to generate an object of interest 130 based on the image and associated text. The object of interest 130 is provided to the database 140 and/or as results 160 via the query generator 150. It will be understood that, in some examples, the system 100 can include additional, alternate or fewer components than those shown in FIG. 1, and that, in some examples, some components may be combined with or incorporated within other components.

In examples, some or all components in the system 100 can be implemented as part of a computing system such as, e.g., an information retrieval system (e.g., a system including a search engine), a social media system, a content delivery system, etc. In examples, some or all components in the system 100 can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the system 100 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the system 100 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIGS. 2A-2C provide diagrams illustrating an example computing system 200 for identifying an object of interest according to one or more examples, with reference to components and features described herein including but not limited to the figures and associated description. Turning to FIG. 2A, as shown in the block diagram the system 200 receives as input an image 102 (FIG. 1, already discussed) and associated text 104 (FIG. 1, already discussed), where the text 104 is associated with the image 102. The system 200 includes an object detector 210, a natural language processing (NLP) model 220 and a similarity model 230. In examples, the object detector 210 and the NLP model 220 correspond to the embeddings generation stage 110 (FIG. 1, already discussed). In examples, the similarity model 230 corresponds to the model 120 (FIG. 1, already discussed).

The object detector 210 detects (e.g., identifies) one or more objects in an image. In examples, the object detector 210 also predicts a category for each object. The object detector 210 operates on the image 102 and generates, for each detected object, object embeddings 215 and a bounding box identifier 216, where each detected object has an associated bounding box. The object detector 210 also, in some examples, provides an object category for each detected object. The object embeddings 215 can include features derived from one or more regions in the image, representing bounding box candidates, and typically each feature forms a vector (e.g., can be a multidimensional vector). Each bounding box identifier 216 is an index or other identifier (such as, e.g., B0, B1, B2, etc.) that uniquely identifies the respective bounding box. The object detector also typically provides, for each bounding box, bounding box coordinates (e.g., box location in the image) which can be used to store and/or display the object (e.g., an object with its associated bounding box as shown in or extracted from the image 102). Notably, bounding box coordinates are not used by the similarity model 230.

The NLP model 220 is a natural language processing model that uses machine learning to analyze and parse text into constituent components (e.g., words or short phrases), and transforms the text string to a vector. The NLP model 220 operates on the text 104 and generates text embeddings 225. The text embeddings 225 can include features of each word derived from the text, and typically form a vector (e.g., can be a multidimensional vector). In some examples the text embeddings 225 include relationships between words. As an example, in some examples the NLP model 220 is a transformer encoder, such as a multilingual transformer encoder. A transformer encoder is described in A. Vaswani et al., “Attention is All You Need,” 31st Conference on Neural Information Processing Systems (NIPS), 2017. A multilingual transformer encoder is a transformer encoder that handles more than one language and can translate from one language to another (e.g., English to Spanish, Spanish to English, etc.). A multilingual transformer encoder generalizes the language capacity of a transformer encoder by introducing machine translation in the pre-training stage. This enables the transformer encoder to learn multiple languages at one time and handle non-English texts. Examples of a multilingual transformer encoder are described in A. Conneau et al., “Cross-lingual Language Model Pretraining,” 33rd Conference on Neural Information Processing Systems (NeurIPS) (2019) and A. Conneau et al., “Unsupervised Cross-lingual Representation Learning at Scale,” Proceedings of the 58th Annual Meeting of the Association for Computational Linguistics, pages 8440-8451, (July 2020), each of which is incorporated herein by reference in its entirety.

The similarity model 230 includes a shared space 232 and a similarity score generator 236. The similarity model 230 receives the object embeddings 215 (e.g., for the objects from the object detector 210) and the text embeddings 225 (e.g., from the NLP model 220) and projects them into the shared space 232. In examples, the similarity model 230 uses linear transformations to map the text and image embeddings space into the shared space 232, where both text and image have the same embedding size. The similarity score generator 236 then computes, for each object, a similarity score based on a relative distance in the shared space 232 between the text embeddings 225 (as projected into the shared space 232) and the respective object embeddings 215 for the object (as projected into the shared space 232). The similarity score can be generated based on one or more of a variety of similarity measures, such as, e.g., cosine similarity, Euclidean distance, etc. The similarity model selects the highest similarity score 236 and, based on the object embeddings that correspond to the highest similarity score, selects the object associated with those object embeddings as the object of interest 240 (e.g., a predicted object of interest). For example, the system 200 can track the index of each bounding box associated with an object, and for the object having the embeddings with the highest score the corresponding bounding box can be used, e.g., to retrieve the image portion containing the object, to display the corresponding bounding box over the image, etc.

Notably, while a transformer encoder (such as a multilingual transformer encoder) can, in examples, be used for generating the text embeddings 225, a transformer encoder is not used for generating the object embeddings 215 (e.g., features derived from regions in the image). Similarly, in examples the similarity model 230 does not use a transformer encoder in any way relating to the object embeddings. Thus, in examples the system 200 (either via the object detector 210 and/or via the similarity model 230) bypasses applying a transformer encoder to features derived from regions in the image. In examples, the object embeddings 215 as provided by the object detector 210 are directly input to the similarity model 230.

In examples, some or all components in the system 200 can be implemented as part of a computing system such as, e.g., the system 100. In examples, some or all components in the system 200 can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the system 200 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the system 200 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Turning now to FIG. 2B, a diagram is provided illustrating an example training process 250 for training the similarity model 230 (for use in the system 200). An image 252 (a training image) is input to an object of interest identification system (e.g., the system 200 in FIG. 2A, already discussed) having an object detector (e.g., the object detector 210 in FIG. 2A, already discussed). The image 252 has associated text 254 (“see my Alpha Fashion Sunglasses with UV Protection!”). The image 252 is processed by the object detector 210 which identifies objects such as a jacket 256 and sunglasses 258 on the person depicted in the image. The object detector also provides bounding boxes for each of the detected objects, e.g., a box 260 for the sunglasses 258 and a box 262 for the jacket 256. It will be understood that while two bounding boxes for objects are shown in FIG. 2B, the object detector 210 can identify additional objects with bounding boxes in the image 252. The object detector 210 provides object embeddings 266 for the sunglasses 258 and object embeddings 267 for the jacket 256.

Because the input image is a training image, it s known (e.g., based on the associated text 254) that the true object of interest is the sunglasses 258. Accordingly, the object embeddings 266 for the sunglasses 258 are identified (e.g., labeled) as positive object (or box) embeddings, and the object embeddings 267 for the jacket 256 are identified (e.g., labeled) as negative object (or box) embeddings. In some examples, negative object embeddings are obtained from an object in a second image (e.g., a second object in a second training image) instead of using the jacket 256 as the negative object. In some examples, selecting negative embeddings corresponding to one negative object in the first training image or another negative object in a second training image can be done on a random basis.

The text 264 is identified based on the text 254 associated with the image 252, and the text 264 is passed to the NLP model 220. The text 264 is processed by the NLP model 220, which generates text embeddings 269.

The similarity model 230 operates to project the text embeddings 269 and the image embeddings 266, 267 into the shared space 232 by applying linear transformations separately to the text embeddings and to the image embeddings. The weights for these transformations are trained, and a loss function is employed to guide the weights so that text embeddings are closer (based on the similarity measure) to the positive object embeddings than to the negative object embeddings. Using a loss function, thus, the similarity model projects the embeddings (e.g., the positive object embeddings 266, the negative object embeddings 267, and the text embeddings 269) into the shared space 232 and the weights are determined (trained) such that the distance between the text embeddings 269 and the positive object embeddings 266 in the shared space 232 is less than the distance between the text embeddings 269 and the negative object embeddings 267 in the shared space 232. This process is repeated for a number of training images, where each training image has associated text and a known true object of interest (e.g., based on the associated text). That is, the similarity model 230 is trained using negative sampling such that the text embeddings 269 are closer to the positive object embeddings 266 than the negative object embeddings 267 in the shared space 232 for the training images. In examples, a hinge loss function is used as the loss function for training. It will be understood that other training mechanisms (e.g., not using negative sampling) can be used for training the similarity model 230.

Once the similarity model 230 is trained, the similarity model 230 (as trained) can be used for evaluation of other images with associated text to identify (e.g., predict) objects of interest. Turning now to FIG. 2C, a diagram is provided illustrating an example evaluation process 270 for evaluating an input image with associated text using a trained similarity model 230 (as part of the system 200). An image 272 (e.g., an input image to be evaluated) is input to the system 200. The image 272 has associated text 274 (“look at me in my Beta Sunglasses with UV Protection!”). The image 272 is processed by the object detector 210 which identifies objects such as a shirt 276 and sunglasses 278 on the person depicted in the image. The object detector also provides bounding boxes for each of the detected objects, e.g., a box 280 for the sunglasses 278 and a box 282 for the shirt 276. The object detector 210 provides object embeddings 286 for the sunglasses 278 and object embeddings 287 for the jacket 276. It will be understood that while two bounding boxes for objects are shown in FIG. 2C, the object detector 210 can identify additional objects with bounding boxes in the image 272, and that object embeddings can be provided for each detected object.

The text 284 is identified based on the text 274 associated with the image 272, and the text 284 is passed to the NLP model 220. For example, the text 284 can be isolated or extracted from the image 272 or the text 274. The text 284 is processed by the NLP model 220, which generates text embeddings 289.

The similarity model 230 projects the object embeddings 286, the object embeddings 287, and the text embeddings 289 into the shared space 232 based on trained weights 234. The similarity model 230 then applies the similarity score generator 236 to the projected embeddings (i.e., the object embeddings 286, the object embeddings 287, and the text embeddings 289) which computes, for each object, a similarity score based on a relative distance in the shared space 232 between the text embeddings 289 (as projected into the shared space 232) and the respective object embeddings—e.g., the object embeddings 286 for the object-1 (as projected into the shared space 232) and the object embeddings 287 for the object-2 (as projected into the shared space 232). The similarity score generator 236 generates a similarity score for each object as described herein with reference to FIG. 2A. The similarity model selects the highest similarity score and, based on the object embeddings that correspond to the highest similarity score, selects the object associated with those object embeddings as the object of interest 240 (e.g., a predicted object of interest).

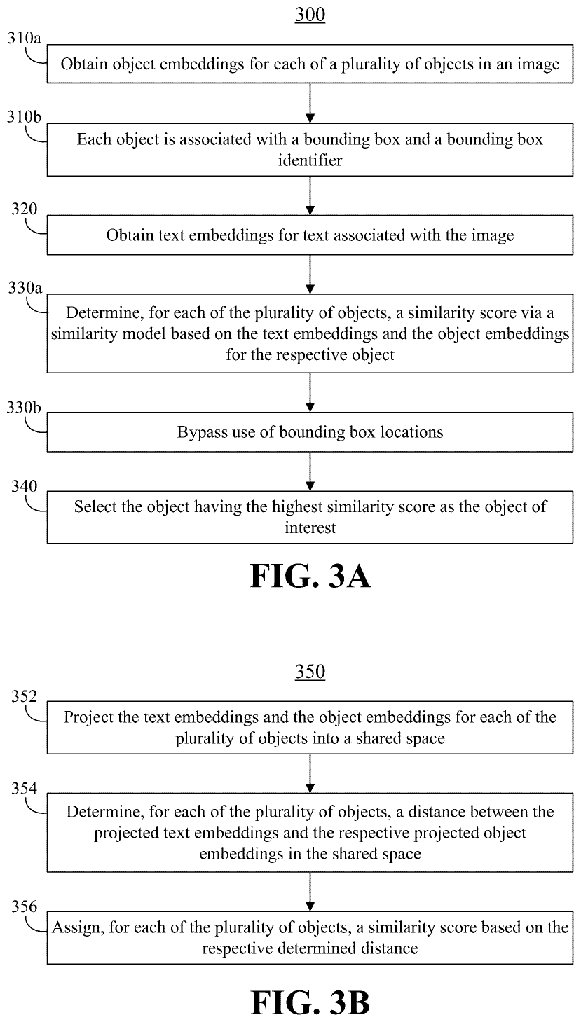

FIG. 3A provides a flow diagram illustrating an example method 300 of identifying an object of interest according to one or more examples, with reference to components and features described herein including but not limited to the figures and associated description. The method 300 can generally be implemented in the system 100 (FIG. 1, already discussed) and/or the system 200 (FIG. 2A, already discussed). More particularly, the method 300 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 300 and/or functions associated therewith can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 310a provides for obtaining object embeddings for each of a plurality of objects in an image, where at block 310b each object is associated with a bounding box and a bounding box identifier. In examples, the object embeddings and associated bounding box for each of the plurality of objects are obtained via applying an object detector to the image, such as the object detector 210 (FIG. 2A, already discussed). In examples, the bounding box identifier is an index or other identifier (such as, e.g., B0, B1, B2, etc.) that uniquely identifies the respective bounding box. In examples, the bounding box identifier corresponds to the bounding box identifier 216 (FIG. 2A, already discussed). In examples, obtaining and/or using object embeddings for each of the plurality of objects comprises bypassing applying a transformer encoder to features derived from regions in the image.

Illustrated processing block 320 provides for obtaining text embeddings for text associated with the image. In examples, the text is isolated or extracted from the image. In examples, the text embeddings are obtained via a natural language processing (NLP) model, such as the NLP model 220 (FIG. 2A, already discussed). In some examples, the NLP model is a transformer encoder. In some examples, the NLP model is a multilingual transformer encoder. Illustrated processing block 330a provides for determining, for each of the plurality of objects, a similarity score via a similarity model based on the text embeddings and the object embeddings for the respective object, where at block 330b determining a similarity score comprises bypassing use of bounding box coordinates (e.g., box locations). In examples, the similarity model corresponds to the similarity model 230 (FIG. 2A, already discussed). In some examples, the similarity model is trained using negative sampling. In some examples, the negative sampling includes selecting sample negative object embeddings corresponding to one of a first negative object in a first training image or a second negative object in a second training image, wherein the first training image includes a positive object in addition to the first negative object. In some examples, selecting negative embeddings corresponding to a first negative object in a first training image or a second negative object in a second training image can be done on a random basis.

Illustrated processing block 340 provides for selecting the object having the highest similarity score as the object of interest. In some examples, the selected object of interest comprises one or more of an object identifier or a bounding box associated with the object of interest.

FIG. 3B provides a flow diagram illustrating an example method 350 of determining a similarity score according to one or more examples, with reference to components and features described herein including but not limited to the figures and associated description. The method 350 can generally be implemented in the system 100 (FIG. 1, already discussed) and/or the system 200 (FIG. 2A, already discussed), such as via the similarity model 230. All or a portion of the method 350 can be substituted for all or a portion of illustrated processing block 330a (FIG. 3A, already discussed). More particularly, the method 350 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 350 and/or functions associated therewith can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 352 provides for projecting the text embeddings and the object embeddings for each of the plurality of objects into a shared space. Illustrated processing block 354 provides for determining, for each of the plurality of objects, a distance between the projected text embeddings and the respective projected object embeddings in the shared space. Illustrated processing block 356 provides for assigning, for each of the plurality of objects, a similarity score based on the respective determined distance.

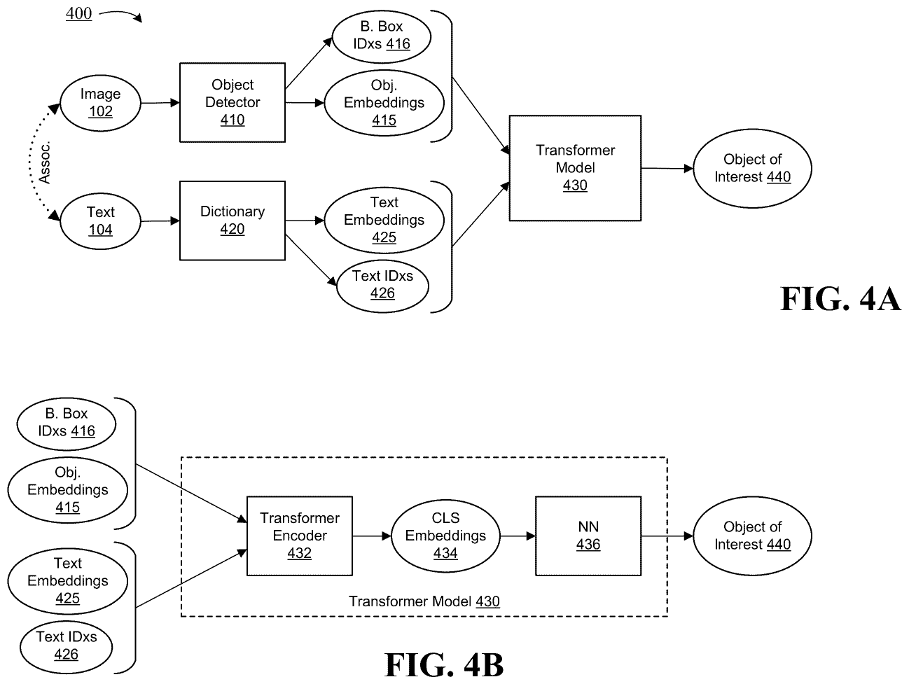

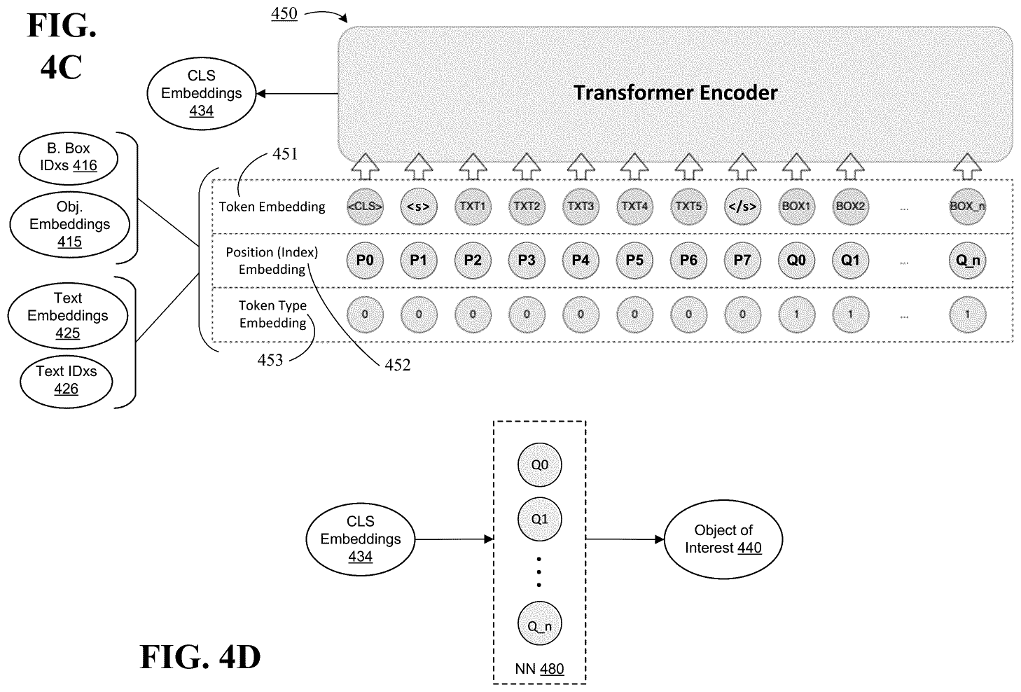

FIGS. 4A-4D provide diagrams illustrating an example computing system 400 for identifying an object of interest according to one or more examples, with reference to components and features described herein including but not limited to the figures and associated description. Turning to FIG. 4A, as shown in the block diagram the system 400 receives as input an image 102 (FIG. 1, already discussed) and associated text 104 (FIG. 1, already discussed), where the text 104 is associated with the image 102. The system 400 includes an object detector 410, a dictionary 420 and a transformer model 430. In examples, the object detector 410 and the dictionary 420 correspond to the embeddings generation stage 110 (FIG. 1, already discussed). In examples, the transformer model 430 corresponds to the model 120 (FIG. 1, already discussed).

The object detector 410 detects one or more objects in an image. The object detector 410 operates on the image 102 and generates, for each detected object, object embeddings 415 and a bounding box identifier 416, where each detected object has an associated bounding box. The object embeddings 415 can include features derived from one or more regions in the image, and typically form a vector (e.g., can be a multidimensional vector). Each bounding box identifier 416 is an index or other identifier (such as, e.g., B0, B1, B2, etc.) that uniquely identifies the respective bounding box. The object detector also typically provides, for each bounding box, bounding box coordinates (e.g., box location in the image) which can be used to store and/or display the object (e.g., an object with its associated bounding box as shown in or extracted from the image 102). Notably, bounding box coordinates are not used by the transformer model 430. In examples, the object detector 410 can be the same as or similar to the object detector 210.

The dictionary 420 converts words to text embeddings. In examples the dictionary 420 includes a lookup table and an embedding matrix. The lookup table is used to convert a word to an index. The index is then used to find and extract corresponding word vectors (e.g., text embeddings) in the embedding matrix. The embedding matrix includes an indexed list of word vectors that is updated during training. Thus after training the dictionary 420 provides, in effect, a defined vocabulary of word vectors. Applying the text 104 to the dictionary 420 results in text embeddings 425 and text identifiers 426. The text embeddings 425 can include features of each word derived from the text, and typically form a vector (e.g., can be a multidimensional vector). In some examples the text embeddings 225 include relationships between words. In some examples, the text embeddings 425 are obtained as a lookup from the defined vocabulary in the dictionary 420 containing embeddings (e.g., a vector) for each word in the text. The text identifiers 426 include, for each word in the text, an index of the place of the word in the text relative to other words in the text. As one example, if the text 104 is the phrase “A man sees a dog,” the text identifiers 426 can be as shown in Table 1:

TABLE 1
Text Identifiers

| | | | | | |
|---|---|---|---|---|---|
| Text 104 | A | man | sees | a | dog |
| Text Idx 426 | P1 | P2 | P3 | P4 | P5 |

The transformer model 430 receives the object embeddings 415 and the bounding box identifiers 416 (e.g., for the objects from the object detector 410) and the text embeddings 425 and text identifiers 426 (e.g., from the dictionary 420) and determines the object of interest 440 based on these inputs to the model. Notably, bounding box coordinates are not used by the transformer model 430. Notably a transformer encoder is not used for generating the object embeddings 415 (e.g., features derived from regions in the image) that are input to the transformer model 430. Further details regarding the transformer model 430 are provided herein with reference to FIGS. 4B-4D.

In examples, some or all components in the system 400 can be implemented as part of a computing system such as, e.g., the system 100. In examples, some or all components in the system 400 can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the system 400 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the system 400 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Turning now to FIG. 4B, a block diagram of the transformer model 430 is provided. The transformer model includes a transformer encoder 432 and a neural network 436. In examples, the transformer encoder 432 is a transformer encoder, such as a multilingual transformer encoder, the same as or similar to the transformer encoder described herein with reference to FIG. 2A. The architecture of the transformer model 430 represents a type of early-fusion multimodal model because it first concatenates the text and object embeddings and then feeds them into the transformer encoder 432.

As described above with reference to FIG. 4A, the transformer model 430 receives the object embeddings 415 and the bounding box identifiers 416 (e.g., for the objects from the object detector 410) and the text embeddings 425 and text identifiers 426 (e.g., from the dictionary 420). These embeddings and identifiers are input to the transformer encoder 432, which generates class (CLS) embeddings 434 based on these inputs. The CLS embeddings 434 are used to predict the index of the correct object (or box) as the object of interest 440. Further details regarding the transformer encoder 432 are provided herein with reference to FIG. 4C.

The neural network (NN) 436 is typically a single-layer perceptron or a multi-layer perceptron. The NN 436 operates on the CLS embeddings 434 and determines the object of interest 440 based on the CLS embeddings 434. Further details regarding the NN 436 are provided herein with reference to FIG. 4D.

Turning now to FIG. 4C, a block diagram of a transformer encoder 450 is provided. The transformer encoder 450 corresponds to, and can be substituted for, the transformer encoder 432 (FIG. 4B, already discussed). The transformer encoder 450 operates on token embeddings 451, position (or index) embeddings 452, and token type embeddings 453, as combined.

The token embeddings 451 include the object embeddings 415 for objects in the image 102 as provided by the object detector 410; these are illustrated in FIG. 4C as token embeddings BOX1 (embeddings for the first object), BOX2 (embeddings for the second object), . . . BOX_n (embeddings for the n^{th} object). The token embeddings 451 also include the text embeddings 425 for the associated text 104 as provided by the dictionary 420; these are illustrated in FIG. 4C as token embeddings TEXT1 (embeddings for the first word in the text 104), TEXT2 (embeddings for the second word in the text 104), TEXT3 (embeddings for the third word in the text 104), TEXT4 (embeddings for the fourth word in the text 104), and TEXT5 (embeddings for the fifth word in the text 104). It will be understood that the number of objects and number of words can vary from the example sown in FIG. 4C. Thus as illustrated in FIG. 4C, the object embeddings 415 along with the text embeddings 425 are provided as input token embeddings to a single transformer encoder.

As illustrated in FIG. 4C, the token embeddings 451 also include three special tokens: <s>, which indicates the start of the text (e.g., start of a sentence or phrase); </s>, which indicates the end of the text (e.g., end of the sentence or phrase); and <CLS>, which is used to classify the index of the object of interest (e.g., index of the bounding box for the object). The CLS embeddings 434 that are the output of the transformer encoder 450 represent the embedding of <CLS>token after going through processing by the transformer encoder 450.

The position (or index) embeddings 452 include the bounding box identifiers 416, each representing an index of the respective object (or bounding box for the object) and the text identifiers 426, each representing an index or position for each word in the text. The bounding box identifiers 416 in the position embeddings 452 are illustrated in FIG. 4C as Q0, Q1, . . . Q_n (each relating to an index of BOX1, BOX2, . . . BOX_n, respectively). The text identifiers 426 are illustrated in FIG. 4C as P2, P3, P4, P5, P6 (relating to TEXT1, TEXT2, TEXT3, TEXT4 and TEXT5, respectively). As illustrated in FIG. 4C, the special tokens are allocated position embeddings P0 (for the <CLS>token), P1 (for the <s>token), and P7 (for the </s>token).

The token type embeddings 453 identify to the transformer encoder 450 the type of embedding. The object embeddings (BOX1, BOX2, . . . BOX_n) have a corresponding token type 1, as shown in FIG. 4C. The text embeddings (TEXT1, TEXT2, TEXT3, TEXT4, TEXT5) have a corresponding token type 0, as shown in FIG. 4C. The special tokens (<CLS>, <s>, and </s>) also have a corresponding token type 0, as shown in FIG. 4C.

The transformer encoder 450 produces as output the CLS embeddings 434. The CLS embeddings 434 correspond to the <CLS>token as processed via the transformer encoder 450, and are. used to predict the object of interest 440. The transformer encoder 450 can be trained in a manner the same as or similar to training for the NLP model 220 (which as discussed above can be a transformer encoder) even though it receives both text and object embeddings.

Turning now to FIG. 4D, a block diagram of a neural network (NN) 480 is provided. The NN 480 corresponds to, and can be substituted for, the NN 436 (FIG. 4B, already discussed). In examples the NN 480 is a mapping from the CLS embeddings 434 to the indices of the various bounding boxes (or objects) corresponding to the object embeddings as input to the transformer model 450. The NN 480 is trained to classify the CLS embeddings 434 and provide as output the object of interest 440 as an index of the bounding box (or object) providing the best match to the text 104 associated with the image 102. For example, given the CLS embeddings 434 relating to n bounding boxes and text, the NN 480 predicts the scores for each box index. The index with the highest score is selected as the index for the object of interest 440. Thus, as one example, if there at most 20 objects (boxes), then the NN 480 will generate 20 scores for the objects (boxes). The object (box) with the highest score is determined as the object of interest 440.

In examples, the NN 480 is a single-layer perceptron or a multi-layer perceptron. The NN 480 can, in examples, be considered a multiclass perceptron because it predicts among multiple classes (e.g., multiple objects/boxes). The NN 480 is typically trained together with the transformer encoder 450.

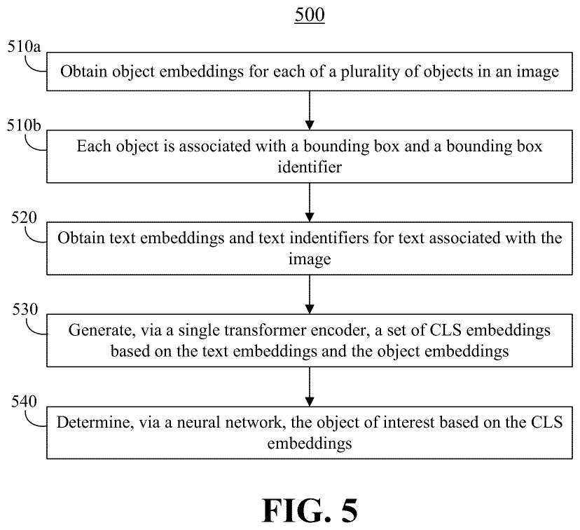

FIG. 5 provides a flow diagram illustrating an example method 500 of identifying an object of interest according to one or more examples, with reference to components and features described herein including but not limited to the figures and associated description. The method 500 can generally be implemented in the system 100 (FIG. 1, already discussed) and/or the system 400 (FIG. 4A, already discussed). More particularly, the method 500 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 500 and/or functions associated therewith can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 510a provides for obtaining object embeddings for each of a plurality of objects in an image, where at block 510b each object is associated with a bounding box and a bounding box identifier. In examples, the object embeddings and associated bounding box for each of the plurality of objects are obtained via applying an object detector to the image, such as the object detector 410 (FIG. 4A, already discussed). In examples, the bounding box identifier is an index or other identifier (such as, e.g., B0, B1, B2, etc.) that uniquely identifies the respective bounding box. In examples, the bounding box identifier corresponds to the bounding box identifier 416 (FIG. 4A, already discussed). In examples, obtaining object embeddings for each of the plurality of objects (e.g., object embeddings to be input to a transformer model having a transformer encoder) comprises bypassing applying a separate transformer encoder to features derived from regions in the image.

Illustrated processing block 520 provides for obtaining text embeddings and text identifiers for text associated with the image. In examples, the text is isolated or extracted from the image. In examples, the text embeddings are obtained via a dictionary having word vectors, such as the dictionary 420 (FIG. 4A, already discussed).

Illustrated processing block 530 provides for generating, via a single transformer encoder, a set of CLS embeddings based on the text embeddings and the object embeddings. In examples, the transformer encoder can be a transformer encoder such as the transformer encoder 450 (FIG. 4C, already discussed). In some examples, generating, via the transformer encoder, the set of CLS embeddings comprises inputting token embeddings (such as the token embeddings 451 in FIG. 4C, already discussed), position embeddings (such as the position embeddings 452 in FIG. 4C, already discussed), and token type embeddings (such as the token type embeddings 453 in FIG. 4C, already discussed) to the transformer encoder. In some examples, the token embeddings include a classifier token, the text embeddings and the object embeddings. In some examples, the position embeddings include a position identifier to identify, for each of the text embeddings, a position of the respective text embedding relative to the text, and, for each of the objects, an index of the bounding box associated with the respective object relative to the other bounding boxes associated with the respective other objects. In some examples, the token type embeddings include token identifiers to identify token embeddings as a text embedding or an object embedding. In some examples, the transformer encoder is a multilingual transformer encoder.

Illustrated processing block 540 provides for determining, via a neural network, the object of interest based on the CLS embeddings. In examples, the neural network comprises one of a single-layer perceptron or a multi-layer perceptron. In examples, the object of interest comprises one or more of an object identifier or a bounding box, such as an index, associated with the object of interest.

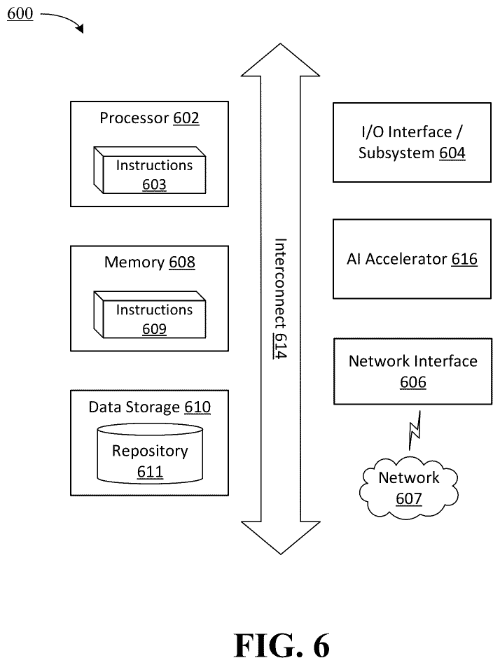

FIG. 6 is a block diagram illustrating an example of an architecture for a computing system 600 for use in identifying an object of interest according to one or more examples, with reference to components and features described herein including but not limited to the figures and associated description. In examples, the computing system 600 can be used to implement any of the devices or components described herein or portion(s) thereof, including the system 100 (FIG. 1), the system 200 (FIG. 2A), the similarity model 230 (FIG. 2A), the system 400 (FIG. 4A), the transformer model 430 (FIG. 4A), and/or any other components of the foregoing systems. In examples, the computing system 600 can be used to implement any of the processes described herein, including the process 250 (FIG. 2B), the process 270 (FIG. 2C), the method 300 (FIG. 3A), the method 350 (FIG. 3B), and/or the method 500 (FIG. 5).

The computing system 600 includes one or more processors 602, an input-output (I/O) interface/subsystem 604, a network interface 606, a memory 608, and a data storage 610. These components are coupled or connected via an interconnect 614. Although FIG. 6 illustrates certain components, the computing system 600 can include additional or multiple components coupled or connected in various ways. It is understood that not all examples will necessarily include every component shown in FIG. 6.

The processor 602 can include one or more processing devices such as a microprocessor, a central processing unit (CPU), a fixed application-specific integrated circuit (ASIC) processor, a reduced instruction set computing (RISC) processor, a complex instruction set computing (CISC) processor, a field-programmable gate array (FPGA), a digital signal processor (DSP), etc., along with associated circuitry, logic, and/or interfaces. The processor 602 can include, or be connected to, a memory (such as, e.g., the memory 608) storing executable instructions 609 and/or data, as necessary or appropriate. The processor 602 can execute such instructions to implement, control, operate or interface with any devices, components, features or methods described herein with reference to FIGS. 1, 2A-2C, 3A-3B, 4A-4D, and 5. The processor 602 can communicate, send, or receive messages, requests, notifications, data, etc. to/from other devices. The processor 602 can be embodied as any type of processor capable of performing the functions described herein. For example, the processor 602 can be embodied as a single or multi-core processor(s), a digital signal processor, a microcontroller, or other processor or processing/controlling circuit. The processor can include embedded instructions 603 (e.g., processor code).

The I/O interface/subsystem 604 can include circuitry and/or components suitable to facilitate input/output operations with the processor 602, the memory 608, and other components of the computing system 600. The I/O interface/subsystem 604 can include a user interface including code to present, on a display, information or screens for a user and to receive input (including commands) from a user via an input device (e.g., keyboard or a touch-screen device).

The network interface 606 can include suitable logic, circuitry, and/or interfaces that transmits and receives data over one or more communication networks using one or more communication network protocols. The network interface 606 can operate under the control of the processor 602, and can transmit/receive various requests and messages to/from one or more other devices (such as, e.g., any one or more of the devices illustrated herein with reference to FIGS. 1, 2A-2C, and 4A-4D. The network interface 606 can include wired or wireless data communication capability; these capabilities can support data communication with a wired or wireless communication network, such as the network 607, and/or further including the Internet, a wide area network (WAN), a local area network (LAN), a wireless personal area network, a wide body area network, a cellular network, a telephone network, any other wired or wireless network for transmitting and receiving a data signal, or any combination thereof (including, e.g., a Wi-Fi network or corporate LAN). The network interface 606 can support communication via a short-range wireless communication field, such as Bluetooth, NFC, or RFID. Examples of network interface 606 can include, but are not limited to, an antenna, a radio frequency transceiver, a wireless transceiver, a Bluetooth transceiver, an ethernet port, a universal serial bus (USB) port, or any other device configured to transmit and receive data.

The memory 608 can include suitable logic, circuitry, and/or interfaces to store executable instructions and/or data, as necessary or appropriate, when executed, to implement, control, operate or interface with any devices, components, features or methods described herein with reference to FIGS. 1, 2A-2C, 3A-3B, 4A-4D, and 5. The memory 608 can be embodied as any type of volatile or non-volatile memory or data storage capable of performing the functions described herein, and can include a random-access memory (RAM), a read-only memory (ROM), write-once read-multiple memory (e.g., EEPROM), a removable storage drive, a hard disk drive (HDD), a flash memory, a solid-state memory, and the like, and including any combination thereof. In operation, the memory 608 can store various data and software used during operation of the computing system 600 such as operating systems, applications, programs, libraries, and drivers. The memory 608 can be communicatively coupled to the processor 602 directly or via the I/O subsystem 604. In use, the memory 608 can contain, among other things, a set of machine instructions 609 which, when executed by the processor 602, causes the processor 602 to perform operations to implement examples of the present disclosure.

The data storage 610 can include any type of device or devices configured for short-term or long-term storage of data such as, for example, memory devices and circuits, memory cards, hard disk drives, solid-state drives, non-volatile flash memory, or other data storage devices. The data storage 610 can include or be configured as a database, such as a relational or non-relational database, or a combination of more than one database. In some examples, a database or other data storage can be physically separate and/or remote from the computing system 600, and/or can be located in another computing device, a database server, on a cloud-based platform, or in any storage device that is in data communication with the computing system 600. In examples, the data storage 610 includes a data repository 611, which in examples can include data for a specific application. In examples, the data repository 611 stores objects of interest and/or images 102 and/or associated text 104 as described herein. In examples, the data repository 611 corresponds to or includes the database 140.

The interconnect 614 can include any one or more separate physical buses, point to point connections, or both connected by appropriate bridges, adapters, or controllers. The interconnect 614 can include, for example, a system bus, a Peripheral Component Interconnect (PCI) bus, a HyperTransport or industry standard architecture bus, a small computer system interface (SCSI) bus, a universal serial bus (USB), IIC (I2C) bus, or an Institute of Electrical and Electronics Engineers (IEEE) standard 694 bus (e.g., “Firewire”), or any other interconnect suitable for coupling or connecting the components of the computing system 600.

In some examples, the computing system 600 also includes an accelerator, such as an artificial intelligence (AI) accelerator 616. The AI accelerator 616 includes suitable logic, circuitry, and/or interfaces to accelerate artificial intelligence applications, such as, e.g., artificial neural networks, machine vision and machine learning applications, including through parallel processing techniques. In one or more examples, the AI accelerator 616 can include hardware logic or devices such as, e.g., a graphics processing unit (GPU) or an FPGA. The AI accelerator 616 can implement any one or more devices, components, features or methods described herein with reference to FIGS. 1, 2A-2C, 3A-3B, 4A-4D, and 5.

In some examples, the computing system 600 also includes a display (not shown in FIG. 8). In some examples, the computing system 600 also interfaces with a separate display such as, e.g., a display installed in another connected device (not shown in FIG. 8). The display can be any type of device for presenting visual information, such as a computer monitor, a flat panel display, or a mobile device screen, and can include a liquid crystal display (LCD), a light-emitting diode (LED) display, a plasma panel, or a cathode ray tube display, etc. The display can include a display interface for communicating with the display. In some examples, the display can include a display interface for communicating with a display external to the computing system 600.

In some examples, one or more of the illustrative components of the computing system 600 can be incorporated (in whole or in part) within, or otherwise form a portion of, another component. For example, the memory 608, or portions thereof, can be incorporated within the processor 602. As another example, the I/O interface/subsystem 604 can be incorporated within the processor 602 and/or code (e.g., instructions 609) in the memory 608. In some examples, the computing system 600 can be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device.

In some examples, the computing system 600, or portion(s) thereof, is/are implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Examples of each of the above systems, devices, components and/or methods, including the system 100 (FIG. 1), the system 200 (FIG. 2A), the similarity model 230 (FIG. 2A), the process 250 (FIG. 2B), the process 270 (FIG. 2C), the method 300 (FIG. 3A), the method 350 (FIG. 3B), the system 400 (FIG. 4A), the transformer model 430 (FIG. 4A), and/or the method 500 (FIG. 5), and/or any other system components, can be implemented in hardware, software, or any suitable combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

Alternatively, or additionally, all or portions of the foregoing systems and/or components and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C # or the like and conventional procedural programming languages, such as the “C” programming language or similar programming languages.

### Additional Notes and Examples

Example M_{A}1 includes a method of identifying an object of interest, comprising obtaining object embeddings for each of a plurality of objects in an image, each object associated with a bounding box and a bounding box identifier, obtaining text embeddings for text associated with the image, determining, for each of the plurality of objects, a similarity score via a similarity model based on the text embeddings and the object embeddings for the respective object, wherein determining a similarity score comprises bypassing use of bounding box coordinates, and selecting the object having the highest similarity score as the object of interest.

Example M_{A}2 includes the method of Example M_{A}1, wherein the object embeddings and associated bounding box for each of the plurality of objects are obtained via applying an object detector to the image.

Example M_{A}3 includes the method of Example M_{A}1 or M_{A}2, wherein obtaining text embeddings for the text associated with the image comprises applying a multilingual transformer encoder to the text.

Example M_{A}4 includes the method of Example M_{A}1, M_{A}2 or M_{A}3, further comprising bypassing applying a transformer encoder to features derived from regions in the image.

Example M_{A}5 includes the method of any of Examples M_{A}1-M_{A}4, wherein determining, for each object, a similarity score via a similarity model comprises projecting the text embeddings and the object embeddings for each of the plurality of objects into a shared space, determining, for each of the plurality of objects, a distance between the projected text embeddings and the respective projected object embeddings in the shared space, and assigning, for each of the plurality of objects, a similarity score based on the respective determined distance.

Example M_{A}6 includes the method of any of Examples M_{A}1-M_{A}5, wherein the similarity model is trained using negative sampling.

Example M_{A}7 includes the method of any of Examples M_{A}1-M_{A}6, wherein the negative sampling includes selecting sample negative object embeddings corresponding to one of a first negative object in a first training image or a second negative object in a second training image, wherein the first training image includes a positive object other than the first negative object.

Example M_{A}8 includes the method of any of Examples M_{A}1-M_{A}7, wherein the object of interest comprises one or more of an object identifier or a bounding box associated with the object of interest.

Example S_{A}1 includes a computing system to identify an object of interest, comprising a processor, and a memory coupled to the processor, the memory comprising instructions which, when executed by the processor, cause the computing system to perform operations comprising obtaining object embeddings for each of a plurality of objects in an image, each object associated with a bounding box and a bounding box identifier, obtaining text embeddings for text associated with the image, determining, for each of the plurality of objects, a similarity score via a similarity model based on the text embeddings and the object embeddings for the respective object, wherein determining a similarity score comprises bypassing use of bounding box coordinates, and selecting the object having the highest similarity score as the object of interest.

Example S_{A}2 includes the computing system of Example S_{A}1, wherein the object embeddings and associated bounding box for each of the plurality of objects are obtained via applying an object detector to the image.

Example S_{A}3 includes the computing system of Example Sal or S_{A}2, wherein obtaining text embeddings for the text associated with the image comprises applying a multilingual transformer encoder to the text.

Example S_{A}4 includes the computing system of Example Sal, S_{A}2 or S_{A}3, wherein the instructions, when executed, cause the computing system to perform further operations comprising bypassing applying a transformer encoder to features derived from regions in the image.

Example S_{A}5 includes the computing system of any of Examples S_{A}1-S_{A}4, wherein determining, for each object, a similarity score via a similarity model comprises projecting the text embeddings and the object embeddings for each of the plurality of objects into a shared space, determining, for each of the plurality of objects, a distance between the projected text embeddings and the respective projected object embeddings in the shared space, and assigning, for each of the plurality of objects, a similarity score based on the respective determined distance.

Example S_{A}6 includes the computing system of any of Examples S_{A}1-S_{A}5, wherein the similarity model is trained using negative sampling.

Example S_{A}7 includes the computing system of any of Examples S_{A}1-S_{A}6, wherein the negative sampling includes selecting sample negative object embeddings corresponding to one of a first negative object in a first training image or a second negative object in a second training image, and wherein the first training image includes a positive object other than the first negative object.

Example S_{A}8 includes the computing system of any of Examples S_{A}1-S_{A}7, wherein the object of interest comprises one or more of an object identifier or a bounding box associated with the object of interest.

Example C_{A}1 includes at least one computer readable storage medium comprising a set of instructions which, when executed by a computing device, cause the computing device to perform operations comprising obtaining object embeddings for each of a plurality of objects in an image, each object associated with a bounding box and a bounding box identifier, obtaining text embeddings for text associated with the image, determining, for each of the plurality of objects, a similarity score via a similarity model based on the text embeddings and the object embeddings for the respective object, wherein determining a similarity score comprises bypassing use of bounding box coordinates, and selecting the object having the highest similarity score as an object of interest.

Example C_{A}2 includes the at least one computer readable storage medium of Example C_{A}1, wherein the object embeddings and associated bounding box for each of the plurality of objects are obtained via applying an object detector to the image.

Example C_{A}3 includes the at least one computer readable storage medium of Example C_{A}1 or C_{A}2, wherein obtaining text embeddings for the text associated with the image comprises applying a multilingual transformer encoder to the text.

Example C_{A}4 includes the at least one computer readable storage medium of Example C_{A}1, C_{A}2 or C_{A}3, wherein the instructions, when executed, cause the computing device to perform further operations comprising bypassing applying a transformer encoder to features derived from regions in the image.

Example C_{A}5 includes the at least one computer readable storage medium of any of Examples C_{A}1-C_{A}4, wherein determining, for each object, a similarity score via a similarity model comprises projecting the text embeddings and the object embeddings for each of the plurality of objects into a shared space, determining, for each of the plurality of objects, a distance between the projected text embeddings and the respective projected object embeddings in the shared space, and assigning, for each of the plurality of objects, a similarity score based on the respective determined distance.

Example C_{A}6 includes the at least one computer readable storage medium of any of Examples C_{A}1-C_{A}5, wherein the similarity model is trained using negative sampling.

Example C_{A}7 includes the at least one computer readable storage medium of any of Examples C_{A}1-C_{A}6, wherein the negative sampling includes selecting sample negative object embeddings corresponding to one of a first negative object in a first training image or a second negative object in a second training image, wherein the first training image includes a positive object other than the first negative object.

Example C_{A}8 includes the at least one computer readable storage medium of any of Examples C_{A}1-C_{A}7, wherein the object of interest comprises one or more of an object identifier or a bounding box associated with the object of interest.

Example M_{B}1 includes a method of identifying an object of interest, comprising obtaining object embeddings for each of a plurality of objects in an image, each object associated with a bounding box and a bounding box identifier, obtaining text embeddings and text identifiers for text associated with the image, generating, via a single transformer encoder, a set of CLS embeddings based on the text embeddings and the object embeddings, and determining, via a neural network, the object of interest based on the CLS embeddings.

Example M_{B}2 includes the method of Example M_{B}1, wherein the object embeddings and associated bounding box for each of the plurality of objects are obtained via applying an object detector to the image.

Example M_{B}3 includes the method of Example M_{B}1 or M_{B}2, wherein the text embeddings are obtained for each word in the text via a dictionary having word vectors.

Example M_{B}4 includes the method of Example M_{B}1, M_{B}2 or M_{B}3, wherein generating, via the transformer encoder, the set of CLS embeddings comprises inputting token embeddings, position embeddings and token type embeddings to the transformer encoder.

Example M_{B}5 includes the method of any of Examples M_{B}1-M_{B}4, wherein the token embeddings include a classifier token, the text embeddings and the object embeddings, wherein the position embeddings include a position identifier to identify, for each of the text embeddings, a position of the respective text embedding relative to the text, and, for each of the objects, an index of the bounding box associated with the respective object relative to the other bounding boxes associated with the respective other objects, and wherein the token type embeddings include token identifiers to identify token embeddings as a text embedding or an object embedding.

Example M_{B}6 includes the method of any of Examples M_{B}1-M_{B}5, wherein the transformer encoder is a multilingual transformer encoder.

Example M_{B}7 includes the method of any of Examples M_{B}1-M_{B}6, wherein the neural network comprises one of a single-layer perceptron or a multi-layer perceptron.

Example M_{B}8 includes the method of any of Examples M_{B}1-M_{B}7, wherein the object of interest comprises one or more of an object identifier or a bounding box associated with the object of interest.

Example S_{B}1 includes a computing system to identify an object of interest, comprising a processor, and a memory coupled to the processor, the memory comprising instructions which, when executed by the processor, cause the computing system to perform operations comprising obtaining object embeddings for each of a plurality of objects in an image, each object associated with a bounding box and a bounding box identifier, obtaining text embeddings and text identifiers for text associated with the image, generating, via a single transformer encoder, a set of CLS embeddings based on the text embeddings and the object embeddings, and determining, via a neural network, the object of interest based on the CLS embeddings.

Example S_{B}2 includes the computing system of Example S_{B}1, wherein the object embeddings and associated bounding box for each of the plurality of objects are obtained via applying an object detector to the image.

Example S_{B}3 includes the computing system of Example S_{B}1 or S_{B}2, wherein the text embeddings are obtained for each word in the text via a dictionary having word vectors.

Example S_{B}4 includes the computing system of Example S_{B}1, S_{B}2 or S_{B}3, wherein generating, via the transformer encoder, the set of CLS embeddings comprises inputting token embeddings, position embeddings and token type embeddings to the transformer encoder.

Example S_{B}5 includes the computing system of any of Examples S_{B}1-S_{B}4, wherein the token embeddings include a classifier token, the text embeddings and the object embeddings, wherein the position embeddings include a position identifier to identify, for each of the text embeddings, a position of the respective text embedding relative to the text, and, for each of the objects, an index of the bounding box associated with the respective object relative to the other bounding boxes associated with the respective other objects, and wherein the token type embeddings include token identifiers to identify token embeddings as a text embedding or an object embedding.

Example S_{B}6 includes the computing system of any of Examples S_{B}1-S_{B}5, wherein the transformer encoder is a multilingual transformer encoder.

Example S_{B}7 includes the computing system of any of Examples S_{B}1-S_{B}6, wherein the neural network comprises one of a single-layer perceptron or a multi-layer perceptron.

Example S_{B}8 includes the computing system of any of Examples S_{B}1-S_{B}7, wherein the object of interest comprises one or more of an object identifier or a bounding box associated with the object of interest.

Example C_{B}1 includes at least one computer readable storage medium comprising a set of instructions which, when executed by a computing device, cause the computing device to perform operations comprising obtaining object embeddings for each of a plurality of objects in an image, each object associated with a bounding box and a bounding box identifier, obtaining text embeddings and text identifiers for text associated with the image, generating, via a single transformer encoder, a set of CLS embeddings based on the text embeddings and the object embeddings, and determining, via a neural network, an object of interest based on the CLS embeddings.

Example C_{B}2 includes the at least one computer readable storage medium of Example CO, wherein the object embeddings and associated bounding box for each of the plurality of objects are obtained via applying an object detector to the image.

Example C_{B}3 includes the at least one computer readable storage medium of Example C_{B}1 or C_{B}2, wherein the text embeddings are obtained for each word in the text via a dictionary having word vectors.

Example C_{B}4 includes the at least one computer readable storage medium of Example C_{B}1, C_{B}2 or C_{B}3, wherein generating, via the transformer encoder, the set of CLS embeddings comprises inputting token embeddings, position embeddings and token type embeddings to the transformer encoder.

Example C_{B}5 includes the at least one computer readable storage medium of any of Examples C_{B}1-C_{B}4, wherein the token embeddings include a classifier token, the text embeddings and the object embeddings, wherein the position embeddings include a position identifier to identify, for each of the text embeddings, a position of the respective text embedding relative to the text, and, for each of the objects, an index of the bounding box associated with the respective object relative to the other bounding boxes associated with the respective other objects, and wherein the token type embeddings include token identifiers to identify token embeddings as a text embedding or an object embedding.

Example C_{B}6 includes the at least one computer readable storage medium of any of Examples C_{B}1-C_{B}5, wherein the transformer encoder is a multilingual transformer encoder.

Example C_{B}7 includes the at least one computer readable storage medium of any of Examples C_{B}1-C_{B}6, wherein the neural network comprises one of a single-layer perceptron or a multi-layer perceptron.

Example C_{B}8 includes the at least one computer readable storage medium of any of Examples C_{B}1-C_{B}7, wherein the object of interest comprises one or more of an object identifier or a bounding box associated with the object of interest.

Examples are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary examples to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although examples are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the examples. Further, arrangements may be shown in block diagram form in order to avoid obscuring examples, and also in view of the fact that specifics with respect to implementation of such block diagram arrangements are highly dependent upon the platform within which the example is to be implemented, i.e., such specifics should be well within purview of one skilled in the art. Where specific details (e.g., circuits) are set forth in order to describe example examples, it should be apparent to one skilled in the art that examples can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the examples can be implemented in a variety of forms. Therefore, while the examples have been described in connection with particular examples thereof, the true scope of the examples should not be so limited since other modifications will become apparent to the skilled practitioner upon a study of the drawings, specification, and following claims.

We claim:

1. A method of identifying an object of interest, comprising:
obtaining object embeddings for each of a plurality of objects in an image, each object associated with a bounding box and a bounding box identifier;
obtaining text embeddings for text associated with the image;
determining, for each of the plurality of objects, a similarity score via a similarity model based on the text embeddings and the object embeddings for the respective object, wherein determining a similarity score comprises bypassing use of bounding box coordinates; and
selecting the object having the highest similarity score as the object of interest.

2. The method of claim 1, wherein the object embeddings and associated bounding box for each of the plurality of objects are obtained via applying an object detector to the image.

3. The method of claim 1, wherein obtaining text embeddings for the text associated with the image comprises applying a multilingual transformer encoder to the text.

4. The method of claim 1, further comprising bypassing applying a transformer encoder to features derived from regions in the image.

5. The method of claim 1, wherein determining, for each object, a similarity score via a similarity model comprises:
projecting the text embeddings and the object embeddings for each of the plurality of objects into a shared space;
determining, for each of the plurality of objects, a distance between the projected text embeddings and the respective projected object embeddings in the shared space; and
assigning, for each of the plurality of objects, a similarity score based on the respective determined distance.

6. The method of claim 1, wherein the similarity model is trained using negative sampling.

7. The method of claim 6, wherein the negative sampling includes selecting sample negative object embeddings corresponding to one of a first negative object in a first training image or a second negative object in a second training image, wherein the first training image includes a positive object other than the first negative object.

8. The method of claim 1, wherein the object of interest comprises one or more of an object identifier or a bounding box associated with the object of interest.

9. A computing system to identify an object of interest, comprising:
a processor; and
a memory coupled to the processor, the memory comprising instructions which, when executed by the processor, cause the computing system to perform operations comprising:
obtaining object embeddings for each of a plurality of objects in an image, each object associated with a bounding box and a bounding box identifier;
obtaining text embeddings for text associated with the image;
determining, for each of the plurality of objects, a similarity score via a similarity model based on the text embeddings and the object embeddings for the respective object, wherein determining a similarity score comprises bypassing use of bounding box coordinates; and
selecting the object having the highest similarity score as the object of interest.

10. The computing system of claim 9, wherein the object embeddings and associated bounding box for each of the plurality of objects are obtained via applying an object detector to the image, wherein obtaining text embeddings for the text associated with the image comprises applying a multilingual transformer encoder to the text, and wherein the instructions, when executed by the processor, cause the computing system to perform further operations comprising bypassing applying a transformer encoder to features derived from regions in the image.

11. The computing system of claim 9, wherein determining, for each object, a similarity score via a similarity model comprises:
projecting the text embeddings and the object embeddings for each of the plurality of objects into a shared space;
determining, for each of the plurality of objects, a distance between the projected text embeddings and the respective projected object embeddings in the shared space; and
assigning, for each of the plurality of objects, a similarity score based on the respective determined distance.

12. The computing system of claim 9, wherein the similarity model is trained using negative sampling, wherein the negative sampling includes selecting sample negative object embeddings corresponding to one of a first negative object in a first training image or a second negative object in a second training image, and wherein the first training image includes a positive object other than the first negative object.

13. A method of identifying an object of interest, comprising:
obtaining object embeddings for each of a plurality of objects in an image, each object associated with a bounding box and a bounding box identifier;
obtaining text embeddings and text identifiers for text associated with the image;
generating, via a single transformer encoder, a set of CLS embeddings based on the text embeddings and the object embeddings; and
determining, via a neural network, the object of interest based on the CLS embeddings.

14. The method of claim 13, wherein the object embeddings and associated bounding box for each of the plurality of objects are obtained via applying an object detector to the image.

15. The method of claim 13, wherein the text embeddings are obtained for each word in the text via a dictionary having word vectors.

16. The method of claim 13, wherein generating, via the transformer encoder, the set of CLS embeddings comprises inputting token embeddings, position embeddings and token type embeddings to the transformer encoder.

17. The method of claim 16, wherein the token embeddings include a classifier token, the text embeddings and the object embeddings, wherein the position embeddings include a position identifier to identify, for each of the text embeddings, a position of the respective text embedding relative to the text, and, for each of the objects, an index of the bounding box associated with the respective object relative to the other bounding boxes associated with the respective other objects, and wherein the token type embeddings include token identifiers to identify token embeddings as a text embedding or an object embedding.

18. The method of claim 13, wherein the transformer encoder is a multilingual transformer encoder.

19. The method of claim 13, wherein the neural network comprises one of a single-layer perceptron or a multi-layer perceptron.

20. The method of claim 13, wherein the object of interest comprises one or more of an object identifier or a bounding box associated with the object of interest.
